(19) United States
(12) Patent Application Publication
(10) Pub. No.: US 2008/0225658 A1
(43) Pub. Date: Sep. 18, 2008

(54) AUDIO REPRODUCING APPARATUS AND AUDIO REPRODUCING METHOD

(75) Inventors: Seigo SUGUTA, Nara (JP); Toshihiko TSUKUMA, Osaka (JP); Takeshi FUJITA, Osaka (JP); Shinji KOJIMA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/044,176

(22) Filed: Mar. 7, 2008

(30) Foreign Application Priority Data
Mar. 13, 2007 (JP) 2007-064048

(51) Int. Cl. G11B 7/00

(52) U.S. Cl. 369/47.14

(57) ABSTRACT

An audio reproducing apparatus of the present invention includes the following: an extracting unit which extracts starting position information from audio packets; a position calculating unit which calculate, based on audio data information included in the audio packets, a position of a starting audio frame; a first difference calculating unit which calculates differences between positions indicated in the starting position information which is extracted by the extracting unit and positions calculated by the position calculating unit; a first reproduction judging unit which judges availability of reproduction for coded audio data based on a change of each of the differences that is calculated by the first difference calculating unit and is calculated for the respective plural audio packets; and a decoding unit which decodes the coded audio data in the case where the first reproduction judging unit judges the coded audio data to be reproducible.

### BACKGROUND OF THE INVENTION

(1) Field of the Invention

The present invention relates to audio reproducing apparatuses and audio reproducing methods, and particularly to an audio reproducing apparatus for decoding an audio data stream.

(2) Description of the Related Art

Audio reproducing apparatuses for reproducing audio data detect errors based on various information when decoding the audio data. For example, an audio reproducing apparatus detects an error in the case where part of the data is damaged by a scratch on a disc or a transmission error. In the case where the error is detected, the audio reproducing apparatus performs recovery processing in order to avoid noise.

For example, there are common techniques, which are used as error detection approaches, for detecting abnormal data when editing and recording the audio data (See Patent reference 1, for example).

In addition, as audio data to be recorded in a music CD and DVD, audio data coded (digitalized) by the Linear Pulse Code Modulation (Linear PCM) scheme is used. Compared with compressed audio data, the Linear PCM data has an extremely small amount of information which can be used for the error detection. Thus, in the Linear PCM data, the noise may possibly stay in the coded data in the case where part of the data has been damaged by the scratch on the disc and the transmission error. In order to avoid the noise, the audio reproducing apparatus can detect the error, using the First Access Unit Pointer in a DVD standard.

The following describes an error detecting process, in a conventional audio reproducing apparatus, which uses the First Access Unit Pointer.

In the DVD standard, there is a definition referred to as the Access Unit (on a frame-to-frame basis, for example). The Access Unit is used as a unit for the synchronization of video and audio output. The First Access Unit Pointer is information showing the starting position of the Access Unit (address) in a packet.

In order to judge whether or not a First Access Unit Pointer value is valid, the audio reproducing apparatus confirms the First Access Unit Pointer value included in the inputted data and a position of a First Access Unit (starting position of an Access Unit in a packet), which is calculated out of the actual data amount. In the case where a shift occurs between the First Access Unit Pointer value included in the inputted data and the position of the First Access Unit calculated out of the actual data amount, the audio reproducing apparatus performs recovery processing in order to avoid producing noise, i.e. discarding currently read-out data once, initializing the reproducing unit, and then restarting the reproducing apparatus. By doing so, the audio reproducing apparatus can avoid the noise resulting from the data shift.

Meanwhile, since the DVD has become popular, DVD format data can be created on a personal computer and recorded in a medium such as a DVD-R. Out of tools creating the DVD format data on a marketed PC, some of the tools create DVD format data which does not conform to the DVD standard. Among the DVD format data which does not conform to the standard, there exists data having the above-mentioned First Access Unit Pointer value accidentally assigned. The data violating the standard can normally be reproduced unless the accidentally assigned First Access Unit Pointer value is used since the audio data itself is properly recorded.

However, when reproducing the Linear PCM data which has been recorded in the DVD, the conventional audio reproducing apparatus confirms the shift between the First Access Unit Pointer value in the Linear PCM data recorded in the DVD and the position of the First Access Unit calculated out of the actual data amount. Thus, in the case where the conventional audio reproducing apparatus tries to reproduce the data having the value of the First Access Unit Pointer accidentally assigned, the apparatus always judges the data to be an error and repeats an error recovery process. In other words, the conventional audio reproducing apparatus fails to reproduce successfully the data having the value of the First Access Unit Pointer accidentally assigned.

More specifically, the problem is that the conventional audio reproducing apparatus fails to reproduce audio data which does not conform to the DVD standard.
Patent reference 1: Japanese Unexamined Patent Application Publication No. 2002-025232.

### SUMMARY OF THE INVENTION

In view of the above problems, the objective of the present invention is to provide an audio reproducing apparatus which can reproduce audio data that does not conform to the DVD standard and the audio reproducing method of the same.

In order to achieve the above objectives, the audio reproducing apparatus, of the present invention, decodes an audio data stream including audio packets to be consecutively inputted, each of the audio packets including: coded audio data which has been coded and includes plural audio frames; starting position information indicating a first position of a starting audio frame among the plural audio frames; and audio data information which indicates the coded audio data, the audio reproducing apparatus including: an extracting unit which extracts the starting position information from the audio packet; a position calculating unit which calculates, for the audio frame, a second position indicating the starting audio frame among the plural audio frames included in the audio packet, based on the audio data information included in the audio packet; a first difference calculating unit which calculates, on the audio packet basis, differences between the respective first positions indicated in the starting position information extracted by the extracting unit and the respective second positions calculated by the position calculating unit; a first reproduction judging unit which judges availability of reproduction for the coded audio data, based on a change in the differences calculated by the first difference calculating unit, the differences being calculated for the audio packets; and a decoding unit which selectively decodes the coded audio data in the case where the first reproduction judging unit judges the coded audio data to be reproducible, and to not decode the coded audio data in the case where the reproduction judging unit judges the coded audio data to be irreproducible.

According to this structure, the first reproduction judging unit judges the availability of reproduction for the coded audio data based on the change in the differences calculated for the audio packets by the first difference calculating unit. Here, when the position indicated in the starting position information is an unauthorized value because of violation, the change in the differences calculated for the audio packets by the first difference calculating unit has regularity. Thus, based on the change in the differences calculated for the audio packets by the first difference calculating unit, the audio reproducing apparatus in the present invention can judge the fact that the position indicated in the starting position information is the unauthorized value due to either the violation or a destruction of the data caused by a scratch on a disc or a transmission error. As a result, the audio reproducing apparatus in the present invention can reproduce audio data which does not conform to the DVD standard, without judging the audio data to be an error. Stated differently, the present invention can provide the audio reproducing apparatus which can reproduce the audio data that does not conform to the DVD standard.

Further, based on the position of the starting audio frame shown with the starting position information and the position of the starting audio frame calculated by the position calculating unit, the audio reproducing apparatus in the present invention can judge whether or not the starting position information is the unauthorized value. Thus, the audio reproducing apparatus in the present invention can detect the starting position information to be the unauthorized value because of the scratch on the disc or the transmission error as an error. This allows the audio reproducing apparatus in the present invention to prevent a noise caused by the scratch on the disc or the transmission error.

In addition, the audio reproducing apparatus may further include: a first holding unit for holding the differences calculated by the first difference calculating unit; a second difference calculating unit which calculates a difference between a difference calculated for a preceding audio packet out of two audio packets included in the audio packets and held in the first holding unit and a difference calculated for a succeeding audio packet out of the two audio packets included in the audio packets and calculated by the first difference calculating unit; and a second holding unit for holding the differences calculated by the second difference calculating unit, wherein the first reproduction judging unit may judge the coded audio data to be: reproducible in the case where the differences held in the second holding unit are constant; and irreproducible in the case where the differences held in the second holding unit are not constant.

According to this structure, the second difference calculating unit calculates changes (differences) of differences between consecutive audio packets, calculated by the first difference calculating unit. In the case where the changes (differences) calculated by the second difference calculating unit are constant, the first reproduction judging unit judges the coded audio data to be reproducible. Here, when the position indicated in the starting position information is the unauthorized value because of the violation, the changes calculated by the second difference calculating unit are constant. Based on the fact whether or not the changes are constant in the differences between: the position indicated in the starting position information between consecutive audio packets; and the position calculated by the position calculation unit, the audio reproducing apparatus in the present invention can, therefore, judge whether or not the position indicated in the starting position information is the unauthorized value due to either the violation or the scratch on the disc or the destruction of the data. As a result, the audio reproducing apparatus in the present invention can reproduce the audio data which does not conform to the standard, without judging the audio data to be an error.

Furthermore, the audio reproducing apparatus may further include a first error judging unit which judges whether or not the first positions indicated in the starting position information extracted by the extracting unit match the corresponding second positions calculated by the position calculating unit, respectively, wherein the decoding unit may selectively: decode the coded audio data in the case where the first error judging unit judges that the first positions match the corresponding second positions, or in the case where the first reproduction judging unit judges the coded audio data to be reproducible; and not decode the coded audio data in the case where the first error judging unit judges that the first positions do not match the corresponding second positions, and the first reproduction judging unit judges the coded audio data to be irreproducible.

According to this structure, the first error judging unit judges whether or not the positions of the starting audio frames indicated in the starting position information match the respective positions, which are calculated by the position calculating unit, of the starting audio frames. This allows the audio reproducing apparatus in the present invention to judge whether or not the starting position information is unauthorized value. Thus, the audio reproducing apparatus in the present invention can detect the starting position information to be the unauthorized value because of the scratch on the disc or the transmission error as an error. This allows the audio reproducing apparatus in the present invention to prevent a noise caused by the scratch on the disc or the transmission error.

Moreover the audio reproducing apparatus may further include a recovering unit which performs recovery processing in the case where: the first error judging unit judges that the first positions do not match the corresponding second positions; and the first reproduction judging unit judges the coded audio data to be irreproducible.

According to this structure, when the starting position information is the unauthorized value because of the scratch on the disc or the transmission error, the recovering unit performs recovery processing, i.e. discarding once currently read-out data, and initializing and restarting the reproducing unit. This prevents the noise caused by the scratch on the disc or the transmission error.

In addition, the audio reproducing apparatus may include: a reproducing unit constructed in hardware and including the extracting unit, the position calculating unit, the first difference calculating unit, and the decoding unit; and a control unit which controls the reproducing unit, the control unit including the first error judging unit and the first reproduction judging unit, and being controlled by software, wherein the reproducing unit may further include a notifying unit which notifies the control unit of the differences calculated by the first difference calculating unit.

According to this structure, the control unit, controlled by software, controls whether or not the reproduction is to be continued. Thus, the audio reproducing apparatus in the present invention can perform error recovery processing which is suitable to a system.

Furthermore, the audio reproducing apparatus may include: a reproducing unit constructed in hardware, and including the extracting unit, the position calculating unit, the first difference calculating unit, the first error judging unit, the reproduction judging unit, and the decoding unit; and a control unit which is controlled by software and controls the reproducing unit.

According to this structure, the reproducing unit constructed in hardware controls whether or not the reproduction is to be continued. Thus, the audio reproducing apparatus in the present invention can perform error recovery processing without overloading the control unit, such as a CPU.

Moreover, the reproducing unit may further include a selecting unit which selects one of a first state and a second state, in the first state, the first error judging unit may judge whether or not the first positions indicated in the starting position information extracted by the extracting unit match the corresponding second positions calculated by the position calculating unit, respectively, in the first state, the first reproduction judging unit may judge the availability of the reproduction for the coded audio data, based on the change in the differences calculated by the first difference calculating unit, the differences being calculated for the audio packets, the control unit may further include: a second error judging unit which judges, in the second state, whether or not the first positions indicated in the starting position information extracted by the extracting unit match the corresponding second positions calculated by the position calculating unit, respectively; and a second reproduction judging unit which judges, in the second state, the availability of the reproduction for the coded audio data, based on the change in the differences calculated by the first difference calculating unit, the differences being calculated for the audio packets, and in the first state, the decoding unit may selectively: decode the coded audio data in the case where the first error judging unit judges the first positions match the corresponding second positions, or in the case where the first reproduction judging unit judges the coded audio data to be reproducible; and not decode the coded audio data in the case where the first error judging unit judges the first positions do not match the corresponding second positions, and the first reproduction judging unit judges the coded audio data to be irreproducible, and in the second state, the decoding unit may selectively: decode audio data in the case where: the second error judging unit judges the first positions match the corresponding second positions; or in the case where the second reproduction judging unit judges the coded audio data to be reproducible; and not decode the coded audio data in the case where the second error judging unit judges the first positions do not match the corresponding second positions, and the second reproduction judging unit judges the coded audio data to be irreproducible.

According to this structure, the selecting unit selects one of the first state and the second state. In the first state, the reproducing unit constructed in hardware controls whether or not the reproduction is to be continued. In the second state, the control unit controlled by software controls whether or not the reproduction is to be continued. Thus, the audio reproducing apparatus in the present invention can judge whether or not the reproduction is to be continued and perform the recovery processing with the most appropriate scheme for the system, providing an interface of which an operation mode is addressable.

In addition, the starting position information may be included in the First Access Unit Pointer.

According to this structure, the audio reproducing apparatus in the present invention can judge whether or not the First Access Unit Pointer is the unauthorized value based on the position of the starting audio frame indicated in the First Access Unit Pointer and the position of the starting audio frame calculated by the position calculating unit. Thus, in the Liner PCM data having a little information for error detection, the audio reproducing apparatus in the present invention can detect the starting position information to be the unauthorized value because of the scratch on the disc or the transmission error as an error. This allows the audio reproducing apparatus in the present invention to avoid the noise in the Liner PCM data.

Moreover, the audio reproducing apparatus in the present invention judges the availability of reproducing the coded audio data based on the change of the differences calculated for the audio packets by the first difference calculating unit. Thus, the audio reproducing apparatus in the present invention can judge the position indicated in the First Access Unit Pointer is to be the unauthorized value due to either the violation or the destruction of the data caused by the scratch on the disc or the transmission error. This allows the audio reproducing apparatus in the present invention to reproduce the audio data which does not conform to the standard, without judging the audio data to be an error.

Furthermore, the audio data information may include: information indicating a quantization bit rate of the coded audio data; information indicating a channel number of the coded audio data; and information indicating a sampling frequency of the coded audio data, and the position calculating unit may calculate, based on the quantization bit rate, the channel number, and the sampling frequency, the first position of the starting audio frame among the plural audio frames.

According to this structure, the position of the starting audio frame can be calculated out of the information included in the audio packets.

In addition, an audio reproducing method for an audio reproducing apparatus, in the present invention, which decodes an audio data stream including audio packets to be consecutively inputted, each of the audio packets including: coded audio data which has been coded and includes plural audio frames; starting position information indicating a first position of a starting audio frame among the plural audio frames; and audio data information which indicates the coded audio data, the audio reproducing method including: extracting the starting position information from the audio packet; position calculating, for the audio frame, a second position of the starting audio frame among the plural audio frames included in the audio packet, based on the audio data information included in the audio packet; a first difference calculating, on the audio packet basis, differences between the respective first positions indicated in the starting position information extracted in the extracting and the respective second positions calculated in the position calculating; reproduction judging availability of reproduction for the coded audio data, based on a change in the differences calculated in the first difference calculating, the differences being calculated for the audio packets; and selectively decoding the coded audio data in the case where the coded audio data is judged to be reproducible, and not decoding in the case where the coded audio data is judged to be irreproducible.

According to this, in the reproduction judging, the availability of reproduction for the coded audio data is judged based on the change in the differences calculated for the audio packets by the first difference calculating. Here, when the position indicated in the starting position information is an unauthorized value because of violation, the change in the differences calculated for the audio packets by the first difference calculating has regularity. Thus, based on the change in the differences calculated for the audio packets by the first difference calculating, the audio reproducing method in the present invention can judge the fact that the position indicated in the starting position information is the unauthorized value due to either the violation or a destruction of the data caused by a scratch on a disc or a transmission error. As a result, the audio reproducing method in the present invention is intended for reproducing audio data which does not conform to the DVD standard, without judging the audio data to be an error. Stated differently, the present invention can provide the audio reproducing method which makes it possible to reproduce the audio data that does not conform to the DVD standard.

Further, based on the position of the starting audio frame indicated in the starting position information and the position of the starting audio frame calculated by the position calculating, the audio reproducing method in the present invention is intended for judging whether or not the starting position information is the unauthorized value. Thus, the audio reproducing method in the present invention is intended for detecting the starting position information to be the unauthorized value because of the scratch on the disc or the transmission error as an error. This makes the audio reproducing method in the present invention possible to prevent a noise caused by the scratch on the disc or the transmission error.

Note that the present invention can not only be implemented as the audio reproducing apparatus and the audio reproducing method mentioned above, but also be implemented as a program causing a computer to execute a characteristic step included in the audio reproducing apparatus. Such a program can be distributed through a storage medium such as a CD-ROM and the like and a transmission medium such as the Internet and the like.

As mentioned above, the present invention provides the audio reproducing apparatus which can reproduce the audio data that does not conform to the standard and the audio reproducing method for use in reproducing the audio data that does not conform to the standard possible.

### FURTHER INFORMATION ABOUT TECHNICAL BACKGROUND TO THIS APPLICATION

The disclosure of Japanese Patent Application No. 2007-064048 filed on Mar. 13, 2007 including specification, drawings and claims is incorporated herein by reference in its entirety.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 is a block diagram illustrating a structure of an audio reproducing apparatus in a first embodiment of the present invention;

FIG. 2 is a diagram illustrating a structure of a Linear PCM audio packet in the DVD-Video standard;

FIG. 3 is a flowchart showing a flow of processing in an error detecting unit in the audio reproducing apparatus in the first embodiment of the present invention;

FIG. 4 is a flowchart showing a flow of processing in a control unit in the audio reproducing apparatus in the first embodiment of the present invention;

FIG. 5 is a block diagram illustrating a structure of an audio reproducing apparatus in a second embodiment of the present invention;

FIG. 6 is a flowchart showing a flow of processing in an error detecting unit in the audio reproducing apparatus in the second embodiment of the present invention;

FIG. 7 is a block diagram illustrating a structure of an audio reproducing apparatus in a third embodiment of the present invention; and

FIG. 8 is a flowchart showing a flow of processing in an error detecting unit in the audio reproducing apparatus in the third embodiment of the present invention.

### DESCRIPTION OF THE PREFERRED EMBODIMENTS

Embodiments of the present invention are described below in detail with reference to the drawings.

### First Embodiment

An audio reproducing apparatus in the first embodiment of the present invention judges an error based on a change of a shift between a value of a First Access Unit Pointer included in audio data and a position of a First Access Unit calculated out of actual data amount, which enables a judgment in that whether the error occurs either by noise or violation of a standard in music data. Thus, the audio reproducing apparatus in the first embodiment of the present invention can reproduce the music data which violates the standard.

First, a structure of the audio reproducing apparatus in the first embodiment of the present invention is described.

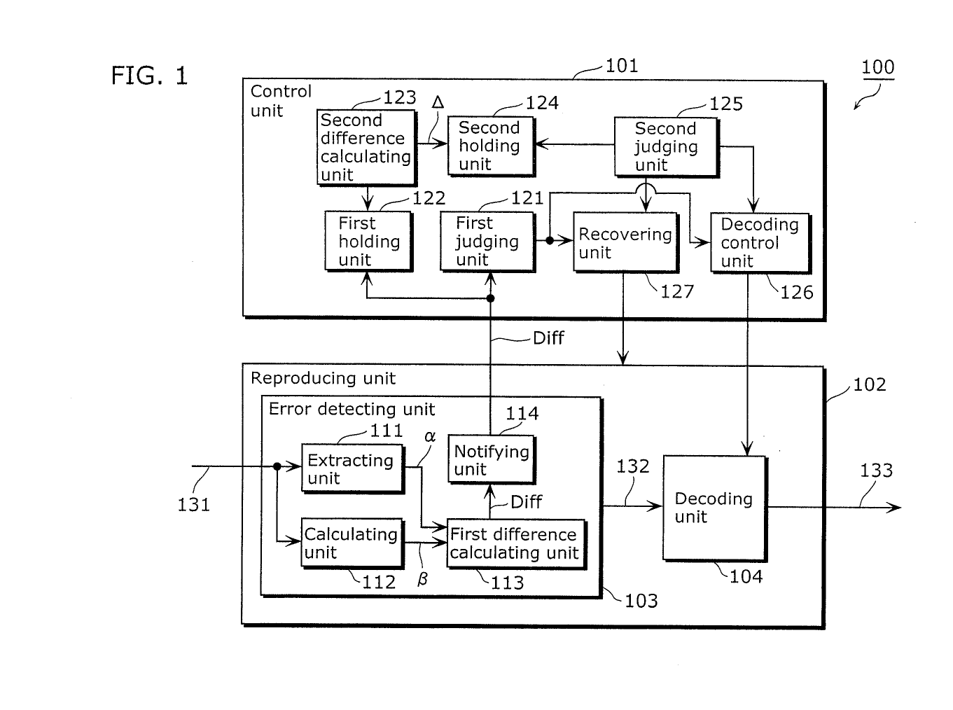

FIG. 1 is a block diagram illustrating the structure of the audio reproducing apparatus in the first embodiment of the present invention.

An audio reproducing apparatus 100 illustrated in FIG. 1 reproduces audio data recorded in a DVD and the like. The audio reproducing apparatus 100 decodes an audio data stream 131 and outputs the decoded audio data stream 131 as decoded audio data 133. The audio data stream 131 is a digitalized Linear PCM audio stream in the DVD-Video standard. In other words, the audio data stream 131 includes plural audio packets which are consecutively stream inputted. The audio reproducing apparatus 100 includes a control unit 101 and a reproducing unit 102.

A structure of the audio data stream 131 shall be described as follows.

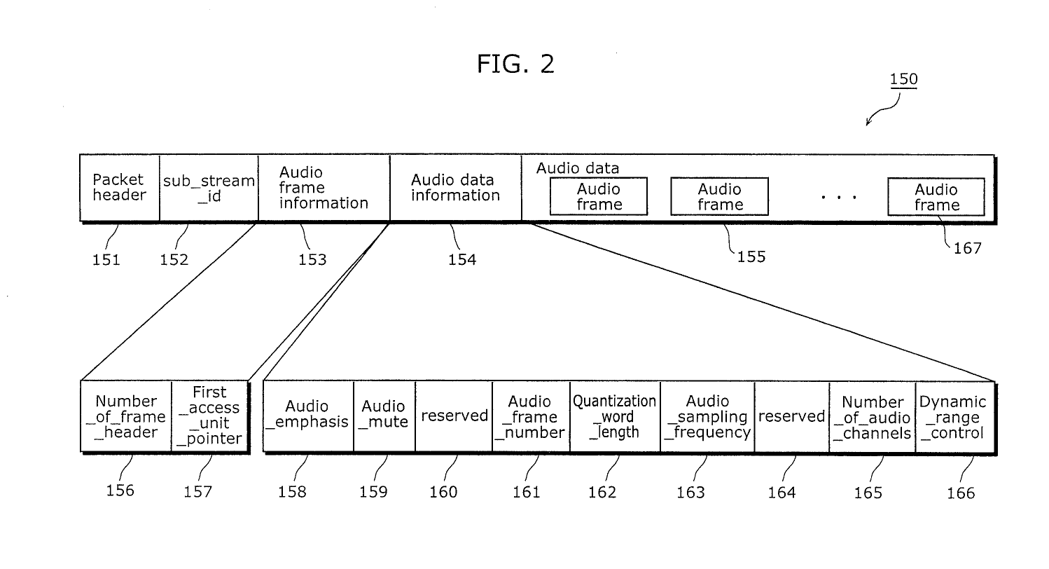

FIG. 2 is a diagram illustrating a structure of the Linear PCM audio packet in the DVD-Video scheme.

A Linear PCM audio packet 150 illustrated in FIG. 2 includes a packet header 151, a Sub_stream_id 152, audio frame information 153, audio data information 154, and audio data 155.

The packet header 151 includes information on the kind of the packet and the length of the data. For example, the packet header 151 includes information that each of audio packets 150 is an audio data stream.

The Sub_stream_id 152 is information indicating the kind of the packet. For example, the Sub_stream_id 152 is information indicating the fact that the audio packet 150 is an audio data stream in the Linear PCM scheme.

The audio data 155 is audio data coded with the Linear PCM scheme, and includes plural audio frames 167.

The audio frame information 153 is information on the plural audio frames 167 which are included in the audio data 155. The audio frame information 153 includes a Number_of_frame_header 156 and a First_access_unit_pointer 157.

The Number_of_frame_header 156 is information showing the number of the headers with the audio frames 167 included in the audio data 155. In other words, the Number_of_frame_header 156 shows the number of the audio frames 167 included in the audio data 155.

The First_access_unit_pointer 157 is information showing the starting position of the first audio frame among the succeeding audio frames 167 included in the audio packet 150. In other words the First_access_unit_pointer 157 is information showing the address of the first audio frame 167 to be accessed among the plural audio frames 167 included in the audio data 155.

The audio data information 154 is information on the audio data 155. The audio data information 154 includes Audio_emphasis 158, Audio_mute 159, reserved 160, Audio_frame_number 161, Quantization_word_length 162, Audio_sampling_frequency 163, reserved 164, Number_of_audio_channels 165, and Dynamic_range_control 166.

The Audio_emphasis 158 is information indicating whether or not the audio data 155 is pre-emphasized.

The Audio_mute 159 is information showing whether the mute on the audio reproducing apparatus is on-state or off-state.

The Audio_frame_number 161 is the frame number which the first audio frame 167 to be accessed has.

The Quantization_word_length 162 is information showing the number of bits to quantize the audio data 155. In other words, the Quantization_word_length 162 shows the quantization bit rate of the audio data 155. For example, the Quantization_word_length 162 provides information on the quantization bit rate of the audio data 155, for example, 16 bits, 20 bits, and 24 bits.

The Audio_sampling_frequency 163 is information showing the sampling frequency of the audio data 155. For example, the Audio_sampling_frequency 163 provides information on the sampling frequency of the audio data 155, i.e. 48 kHz or 96 kHz.

The Number_of_audio_channels 165 is information showing the number of the audio channels, a channel number.

The Dynamic_range_control 166 is control information on a Dynamic range.

The reproducing unit 102 decodes the audio data stream 131, as well as detects an error therein. The reproducing unit 102 is constructed in a dedicated circuit (hardware) to the unit. For example, the reproducing unit 102 is a semi-conductor integrated circuit structured of one or more chips. The reproducing unit 102 includes an error detecting unit 103 and a decoding unit 104.

The error detecting unit 103 detects the error in the audio data stream 131.

The error detecting unit 103 includes an extracting unit 111, a calculating unit 112, a first difference calculating unit 113, and a notifying unit 114.

The decoding unit 104 decodes the audio data 155 included in the audio data stream 132 and outputs the decoded audio data 155 as the decoded audio data 133. Here, the audio data stream 132, which is the same signal as the audio data stream 131, is a digital audio data stream outputted via the error detecting unit 103.

The control unit 101 controls the reproducing unit 102. Meanwhile, the control unit 101 is controlled by the software, that is, the control unit 101 implements the functions shown in FIG. 1, executing the program. For example, either a micro computer or a CPU can be the control unit 101. The control unit 101 includes a first judging unit 121, a first holding unit 122, a second difference calculating unit 123, a second holding unit 124, a second judging unit 125, a decoding control unit 126, and a recovering unit 127.

The extracting unit 111 extracts the First_access_unit_pointer 157 from the audio packet 150 included in the audio data stream 131.

The calculating unit 112 calculates β, the position of the starting audio frame 167 among the plural audio frames 167 included in the audio packet 150, out of the audio data information 154 included in the audio packet 150. Specifically, the calculating unit 112 calculates β, the position of the starting audio frame 167, based on the Quantization_word_length 162, the Audio_sampling_frequency 163, and the Number_of_audio_channels 165.

The first difference calculating unit 113 calculates a difference Diff between the position α and the position β. Here, the position α is the position of the starting audio frame 167 shown with the First_access_unit_pointer 157 which is extracted from the extracting unit 111, and the position β is the position of the starting audio frame 167 calculated by the calculating unit 112.

The notifying unit 114 notifies the control unit 101 of each of differences Diff calculated by the first difference calculating unit 113.

The first judging unit 121 judges whether or not the position α matches with the position β. Here, the position α is the position shown with the First_access_unit_pointer 157 which is extracted from the extracting unit 111, and the position β is the position calculated by the calculating unit 112 is identical. For example, the first judging unit 121 judges that the position α: matches with the position β when the difference Diff notified by the notifying unit 114 is “0”; and does not match the position β when the difference Diff is other than “0”.

The first holding unit 122 holds the difference Diff which has been calculated by the first difference calculating unit 113 and notified by the notifying unit 114. The first holding unit 122 also holds the differences Diff each of which is calculated for the respective plural audio packets 150 to be inputted consecutively.

The second difference calculating unit 123 calculates a difference Diff between succeeding two audio packets. Specifically, the second difference calculating unit 123 calculates a difference Δ. Each of differences Δ is a difference between: the difference Diff which is calculated for the preceding audio packet of the two consecutive audio packets and is held in the first holding unit 122; and the difference Diff which is calculated for the second audio packet 150 of the two consecutive audio packets 150 and calculated by the first difference calculating unit 113. In other words, the second difference calculating unit 123 calculates the differences Δ each of which is the change of the respective differences Diff between the plural audio packets 150 to be consecutively inputted.

The second holding unit 124 holds plural differences Δ, including the difference Δ, which are calculated by the second difference calculating unit 123.

In the case where the first judging unit 121 judges that the position α does not match the position β, the second judging unit 125 judges availability of the reproduction for the audio data 155 included in the audio data stream 131 according to the change of the differences Diff which are calculated by the first difference calculating unit 113 and each of which calculated for the respective plural audio packets 150. Specifically, in the case where the plural differences Δ held in the second holding unit 124 are constant, the second judging unit 125 judges the audio data 155, included in the audio data stream 131, to be reproducible. In the case where the plural differences Δ held in the second holding unit 124 are not constant, the second judging unit 125 judges the audio data 155, included in the audio data stream 131, to be irreproducible. In other words, the second judging unit 125 judges the audio data 155 to be: reproducible when the plural differences Δ between the consecutive audio packets 150 are constant; and irreproducible when the plural differences Δ not constant.

Based on judgment results obtained from the first judging unit 121 and the second judging unit 125, the decoding control unit 126 controls decode processing on the audio data stream 132, the decode processing which is performed by the decoding unit 104. Specifically, when the first judging unit 121 judges that the position α extracted by the extracting unit 111 matches with the position β calculated by the calculating unit 112, the decoding unit 104, controlled by the decoding control unit 126, decodes the audio data 155 included in the audio data stream 132. In the case where: the first judging unit 121 judges the position α does not match the position β; and the second judging unit 125 judges the audio data 155 to be reproducible, then the decoding unit 104, controlled accordingly by the decoding control unit 126, decodes the audio data 155 included in the audio data stream 132. In the case where: the first judging unit 121 judges that the position α does not match the position β; and the second judging unit 125 judges the audio data 155 to be irreproducible, then the decoding unit 104, controlled accordingly by the decoding control unit 126, does not decode the audio data 155 included in the audio data stream 132.

The recovering unit 127 performs recovery processing when the first judging unit 121 judges that the position α does not match the position β and the second judging unit 125 judges the audio data 155 to be irreproducible. Specifically, the recovery processing performed by the recovering unit 127 is to discard once currently read out data, and initialize and restart the reproducing unit 102.

Next, operations of the audio reproducing apparatus 100 in the first embodiment of the present invention are described.

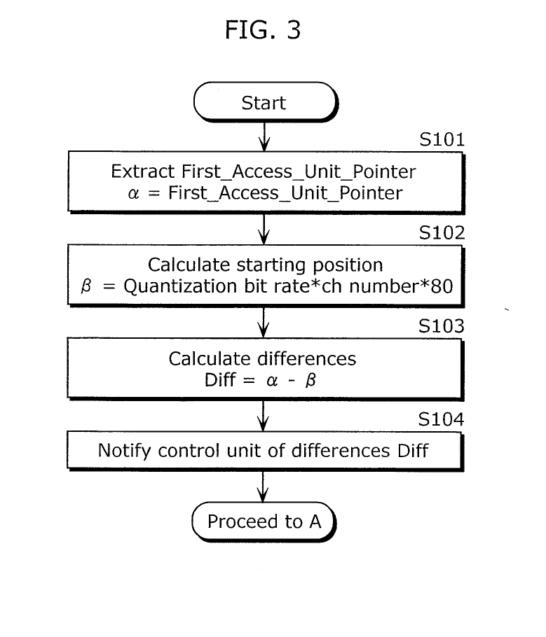

FIG. 3 is a flowchart showing a flow of processing in the error detecting unit 103.

As shown in the FIG. 3, first, the extracting unit 111 extracts the position α; that is, the position of the starting audio frame 167 shown with the First_access_unit_pointer 157 which is included in the audio data stream 131 (S101).

Next, the calculating unit 112 calculates the position β; that is, the position of the starting audio frame 167 calculated out of the audio data information 154 (S102). Specifically, the calculating unit 112 calculates, out of the Audio_sampling_frequency 167 (sampling frequency), a sample number included in one audio frame 167 (80, for example). The calculating unit 112 calculates a data size of the one audio frame 167 out of the Quantization_word_length 162, the calculated sample number (80, for example), and the Number_of_audio_channel 165 (the quantization bit rate by the sample number by the channel number). The calculating unit 112 calculates the position β, the position of the starting audio frame 167 included in the audio packet 150, by accumulating the data sizes from the beginning of the processing start.

Next, the first difference calculating unit 113 calculates the difference Diff between the position α and the position β. Here, the position α is the position of the starting audio frame 167 shown with the First_access_unit_pointer 157 which is extracted from the extracting unit 111, and the position β is the position of the starting audio frame 167 calculated by the calculating unit 112 (S103).

Next, the notifying unit 114 notifies the control unit 101 of the difference Diff calculated by the first difference calculating unit 113 (S104).

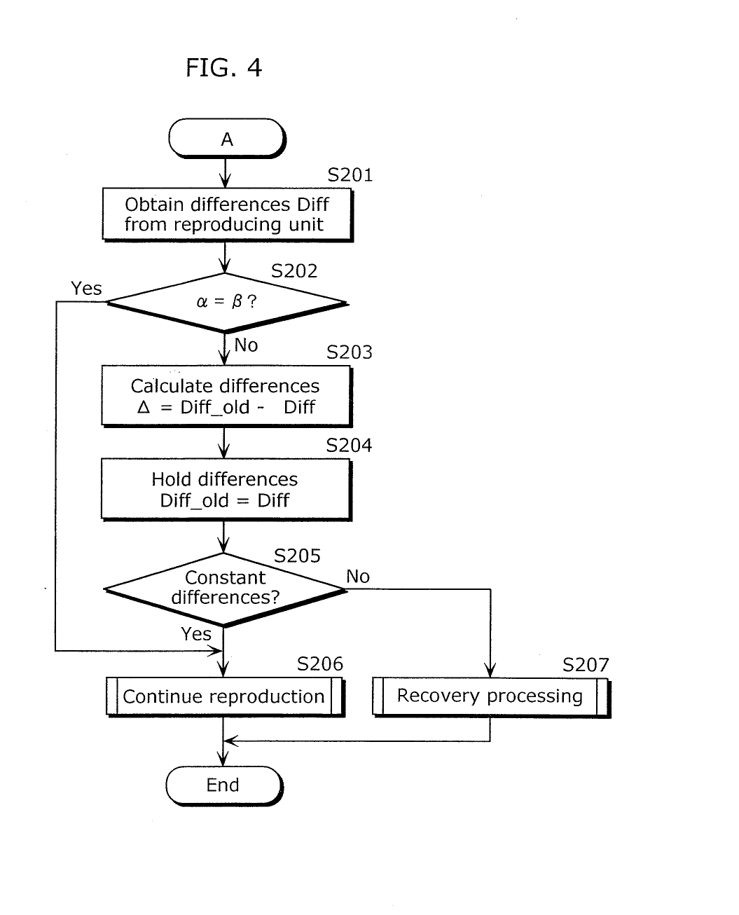

FIG. 4 is the flowchart showing the flow of the processing in the control unit 101.

As shown in FIG. 4, the control unit 101 obtains the difference Diff which has been notified by the notifying unit 114 (S201). The first holding unit 122 holds the difference Diff which has been notified by the notifying unit 114.

The first judging unit 121 judges whether or not the position α matches with the position β (S202). In the case where the first judging unit 121 judges that the position α matches with the position β (S202: Yes); that is, the position α shown with the First_access_unit_pointer 157 is correct, the decoding unit 104, controlled by the decoding control unit 126, decodes the audio data stream 132. In other words, the audio reproducing apparatus 100 continues reproduction processing (S206).

In the meantime, when the first judging unit 121 judges that the position α does not match the position β (S202: No); that is, the position α shown with the First_access_unit_pointer 157 is not correct, the second difference calculating unit 123 calculates the difference Δ (S203). Here, the difference Δ is a difference between a difference Diff_old which is calculated for the immediately preceding audio packet 150 and is held in the first holding unit 122 and the difference Diff which has been newly calculated and held in the first holding unit 122 (S203). The second holding unit 124 holds the difference Δ calculated by the second difference calculating unit 123.

Next, the first holding unit 122 holds the newly calculated difference Diff as the difference Diff_old (S204).

Then, the second judging unit 125 judges whether or not the plural differences Δ held in the second holding unit 124 are constant (S205). Specifically, the second judging unit 125 judges the audio data stream 131 to be reproducible when the plural differences Δ held in the second holding unit 124 are constant; that is, the respective differences Δ between the plural audio packets to be consecutively inputted are constant (S205: Yes). Furthermore, the second judging unit 125 judges the audio data stream 131 to be irreproducible when the plural differences Δ held in the second holding unit 124 vary; that is, the respective differences Δ between the plural audio packets to be consecutively inputted not constant (S205: No).

Here, there is a case where a value of the First_access_unit_pointer 157 is in the violation of the standard when the audio data stream 131 is data created on a PC encoder. In addition, when the data violates the standard, each value of the differences Diff shifts by constant change between the consecutive audio packets. In other words, the differences Δ between the plural audio packets to be consecutively inputted are constant.

On the other hand, in the case where the value of the First_access_unit_pointer 157 is unauthorized due to destruction of part of the data caused by a scratch on a disc or a transmission error, the difference Diff changes on an irregular basis. In other words, the differences Δ between plural audio packets to be consecutively inputted vary respectively, and are not constant.

Through the above mentioned fact, the audio reproducing apparatus 100 in the first embodiment of the present invention judges whether or not the plural differences Δ held in the second holding unit 124 are constant. As the result, a value of the First_access_unit_pointer 157 is judged to be unauthorized because either the value is in the violation of the standard, or the data is damaged.

In the case where the differences Δ are constant (S205: Yes), the decoding unit 104, controlled accordingly by the decoding control unit 126, decodes the audio data stream 132. In other words, the audio reproducing apparatus 100 continues reproduction processing (S206).

Meanwhile, in the case where the differences Δ are not constant (S205: No), the decoding unit 104, controlled accordingly by the decoding control unit 126, halts the decoding of the audio data stream 132. Furthermore, the recovering unit 127 discards once currently read out data, and performs recovery processing such as initialization and restart of the reproducing unit 102 (S207).

Following one of the reproduction continuation (Step S206) and recovery processing (Step S207), the audio reproducing apparatus 100 applies processing, shown in FIG. 3 and FIG. 4, to the succeeding audio packets 150.

Through the above operations, the audio reproducing apparatus 100 in the first embodiment of the present invention calculates, based on the audio data information 154, the position β of the starting audio frame 167. The first difference calculating unit 113 calculates the difference Diff between the position α, indicating the position of the starting audio frame 167 shown with the First_access_unit_pointer 157, and the position β. The second difference calculating unit 123 calculates the differences Δ each of which is the change of the respective differences Diff between the consecutive audio packets. When the differences Δ are constant, the second judging unit 125 judges the First_access_unit_pointer 157 to be unauthorized due to the violation of the standard. Moreover, when the differences Δ are not constant, the second judging unit 125 judges the First_access_unit_pointer 157 to be unauthorized due to the destruction of the data.

Through the above mentioned process, the audio reproducing apparatus 100 in the first embodiment of the present invention judges the value of the First_access_unit_pointer 157 to be unauthorized because either the value is in the violation of the standard, or the data is damaged. Thus, the audio reproducing apparatus 100 in the first embodiment of the present invention can avoid the noise generated resulting from data shift which is caused by the scratch on the disc or the transmission error and damages part of the data. In addition, the audio reproducing apparatus 100 in the first embodiment of the present invention can reproduce the music data which conventional audio reproducing apparatuses judge to be an error and does not conform to the standard.

Furthermore, the audio reproducing apparatus 100 in the first embodiment of the present invention judges the value of the First_access_unit_pointer 157 to be authorized in the case where the position α matches with the position β. As a result, when the value of the First_access_unit_pointer 157 is authorized, the audio reproducing apparatus 100 in the first embodiment of the present invention can continue reproduction processing.

Moreover, the audio reproducing apparatus 100 in the first embodiment of the present invention, by the control unit 101 which is under the control of the software, controls whether or not: the reproduction is to be continued; and the recovery processing is performed. As a result, the audio reproducing apparatus 100 in the first embodiment of the present invention can perform error recovery processing which is suitable to a system.

Note that in the above description, the decoding unit 104 is intended to decode the audio data stream 132 which is the audio data stream 131 inputted via the error detecting unit 103; however, the decoding unit 104 may also decode the audio data stream 131.

Furthermore, in the above description, the extracting unit 111, the calculating unit 112, and the first difference calculating unit 113 intend to be included in the reproducing unit 102 which is constructed in hardware; however, all or part of the extracting unit 111, the calculating unit 112, and the first difference calculating unit 113 may be implemented in the form of software. In addition, all or part of the extracting unit 111, the calculating unit 112, and the first difference calculating unit 113 may be included in the control unit 101.

Moreover, the above description intends the first judging unit 121, the first holding unit 122, the second difference calculating unit 123, the second holding unit 124, the second judging unit 125, the decoding control unit 126, and the recovering unit 127 to be included in the control unit 101 which is controlled by the software; however, part of the first judging unit 121, the first holding unit 122, the second difference calculating unit 123, the second holding unit 124, the second judging unit 125, the decoding control unit 126, and the recovering unit 127 may also be constructed in hardware. For example, the first holding unit 122 and the second holding unit 124 may be a RAM, a non-volatile memory, or a hard disc which the audio reproducing apparatus 100 provides. Furthermore, part of the first judging unit 121, the first holding unit 122, the second difference calculating unit 123, the second holding unit 124, the second judging unit 125, the decoding control unit 126, and the recovering unit 127 may also be included in the reproducing unit 102. For example, the reproducing unit 102 may include the first holding unit 122 and the second difference calculating unit 123, and calculate the difference Δ, and the notifying unit 114 may notify the control unit 101 of the difference Δ.

### Second Embodiment

In an audio reproducing apparatus in a second embodiment of the present invention, a reproducing unit, which is constructed in hardware, controls whether or not: reproduction is to be continued; and recovery processing is to be performed. This allows the reproducing unit to perform error detection and error recovery processing without overloading a control unit.

First, a structure of the audio reproducing apparatus in the second embodiment of the present invention shall be described.

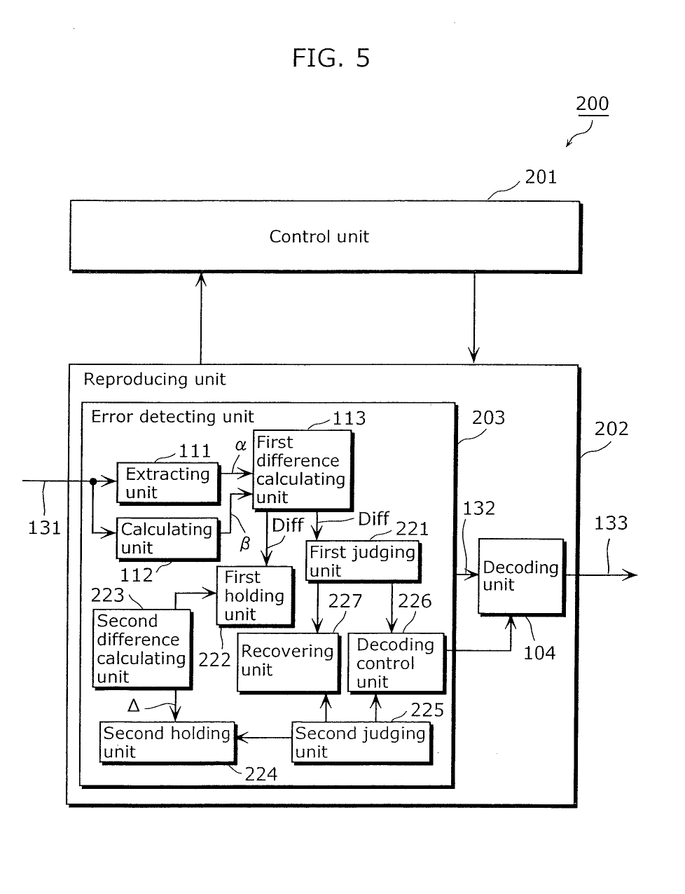

FIG. 5 is a block diagram showing a structure of the audio reproducing apparatus in the second embodiment of the present invention. Note that the same elements as those in FIG. 1 share the same numerical references. Thus, detailed descriptions shall be omitted.

An audio reproducing apparatus 200 shown in FIG. 5 decodes an audio data stream 131 and outputs the decoded audio data stream 131 as decoded audio data 133. The audio reproducing apparatus 200 includes a control unit 201 and a reproducing unit 202.

The reproducing unit 202 decodes the audio data stream 131, as well as detects the error therein. The reproducing unit 202 is constructed in a dedicated circuit (hardware) to the unit. For example, the reproduction unit 202 is a semi-conductor integrated circuit structured of one or more chips. The reproducing unit 202 includes an error detecting unit 203 and a decoding unit 104.

The error detecting unit 203 detects the error in the audio data stream 131. The error detecting unit 203 includes an extracting unit 111, a calculating unit 112, a first difference calculating unit 113, a first judging unit 221, a first holding unit 222, a second difference calculating unit 223, a second holding unit 224, a second judging unit 225, a decoding control unit 226, and a recovering unit 227. Note that the functions of the first judging unit 221, the first holding unit 222, the second difference calculating unit 223, the second holding unit 224, the second judging unit 225, the decoding control unit 226, and the recovering unit 227 are respectively equivalent to those of the first judging unit 121, the first holding unit 122, the second difference calculating unit 123, the second holding unit 124, the second judging unit 125, the decoding control unit 126, and the recovering unit 127 shown in FIG. 1

The control unit 201, which is controlled by software, controls the reproducing unit 202.

As described above, the audio reproducing apparatus 200 of the second embodiment of the present invention is different from the audio reproducing apparatus 100 of the first embodiment in that the first judging unit 221, the first holding unit 222, the second difference calculating unit 223, the second holding unit 224, the second judging unit 225, the decoding control unit 226, and the recovering unit 227 are included in the reproducing unit 202 constructed in hardware.

Next, operations of the audio reproducing apparatus 200 in the second embodiment of the present invention shall be described.

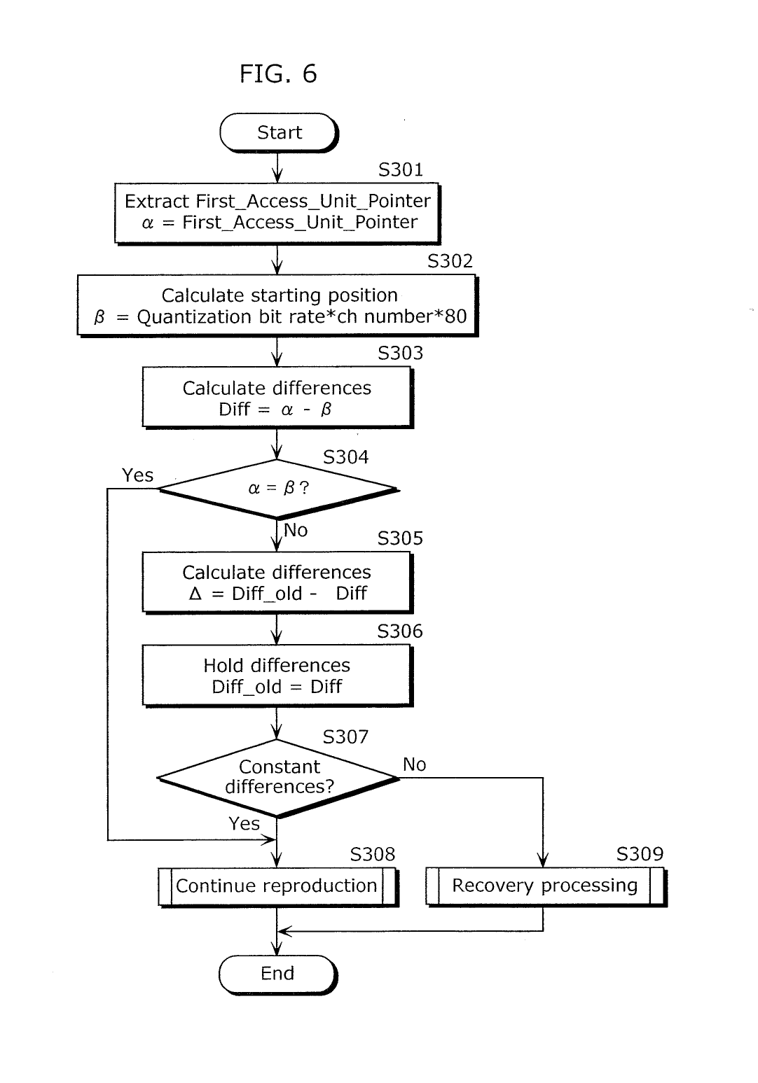

FIG. 6 is a flowchart showing a flow of processing in the error detecting unit 203.

Processing from Steps S301 to S303 shown in FIG. 6 is equivalent to that from respective Steps S101 to S103 in FIG. 3, thus the description shall be omitted.

Processing from Steps S304 to S309 shown in FIG. 6 is equivalent to that from respective Steps S202 to S207 in FIG. 3.

The first holding unit 222 holds a difference Diff calculated by the first difference calculating unit 113 at Step S303.

The first judging unit 221 judges whether or not position α matches with position β (S304). In the case where the first judging unit 221 judges that the position α matches with the position β (S304: Yes); that is, the position α shown with a First_access_unit_pointer 157 is correct, the decoding unit 104, controlled accordingly by the decoding control unit 226, decodes the audio data stream 132. In other words, the audio reproducing apparatus 200 continues reproduction processing (S308).

In the meantime, when the first judging unit 221 judges that the position α does not match the position β (S304: No); that is, the position α shown with the First_access_unit_pointer 157 is not correct, the second difference calculating unit 223 calculate a difference Δ. Here, the difference Δ is a difference between a difference Diff_old which is calculated for an immediately preceding audio packet 150 and is held in the first holding unit 222 and the difference Diff which has been newly calculated and held in the first holding unit 222 (S305). The second holding unit 224 holds each of differences Δ calculated by the second difference calculating unit 223.

Next, the first holding unit 222 holds the newly calculated difference Diff as a difference Diff_old (S306).

Then, the second judging unit 225 judges whether or not the plural differences Δ held in the second holding unit 224 are constant (S307). Specifically, the second judging unit 225 judges the audio data stream 131 to be reproducible when the plural differences Δ held in the second holding unit 224 are constant; that is, the respective differences Δ between the plural audio packets to be consecutively inputted are constant (S307: Yes). Meanwhile, the second judging unit 225 judges the audio data stream 131 to be irreproducible when the plural differences Δ held in the second holding unit 224 are not constant; that is, the respective differences Δ between the plural audio packets to be consecutively inputted are not equal (S307: No).

In the case where the differences Δ are constant (S307: Yes), the decoding unit 104 decodes the audio data stream 132 by the control of the decoding control unit 226. In other words, the audio reproducing apparatus 200 continues reproduction processing (S308).

Meanwhile, in the case where the differences Δ are not constant (S307: No), the decoding unit 104, controlled accordingly by the decoding control unit 226, halts the decoding of the audio data stream 132. Furthermore, the recovering unit 227 discards once currently read out data, and performs recovery processing such as initialization and restart of the reproducing unit 202 (S309).

Following one of the reproduction continuation (S308) and recovery processing (S309), the audio reproducing apparatus 200 applies processing shown in FIG. 6 to the succeeding audio packets 150.

Through the above mentioned process, the audio reproducing apparatus 200 in the second embodiment of the present invention, as well as the audio reproducing apparatus 100 in the first embodiment, judges the value of the First_access_unit_pointer 157 to be unauthorized because either: the value is in the violation of the standard; or the data is damaged. Thus, the audio reproducing apparatus 200 in the second embodiment of the present invention can avoid noise resulting from data shift which is caused by a scratch on a disc or a transmission error and damages part of data. In addition, the audio reproducing apparatus 200 in the second embodiment of the present invention can reproduce the music data which conventional audio reproducing apparatuses judges to be an error and does not conform to the standard.

Furthermore, in the audio reproducing apparatus 200 in the second embodiment of the present invention, the reproducing unit 202 controls whether or not: the reproduction is to be continued; and recovery processing is to be performed. As a result, the audio reproducing apparatus 200 in the second embodiment of the present invention can perform error detection and error recovery processing without overloading the control unit 201.

Note that in the above description, the first judging unit 221 intends to judge whether or not the position α matches the position β based on the difference Diff, following the calculation of the difference Diff (S303). Meanwhile, the judgment whether or not the position α matches with the position β may be made before the calculation of the difference Diff (between S302 and S303). When the position α matches with the position β as the above result, calculation processing for the difference Diff (S303) may be omitted.

### Third Embodiment

An audio reproducing apparatus in a third embodiment of the present invention has a function of selectively causing a reproducing unit and a control unit to control whether or not: reproduction is to be continued; and recovery processing is to be performed. As a result, the audio reproducing apparatus in the third embodiment of the present invention can perform recovery processing with the most appropriate scheme for the system.

First, a structure of the audio reproducing apparatus in the third embodiment of the present invention shall be described.

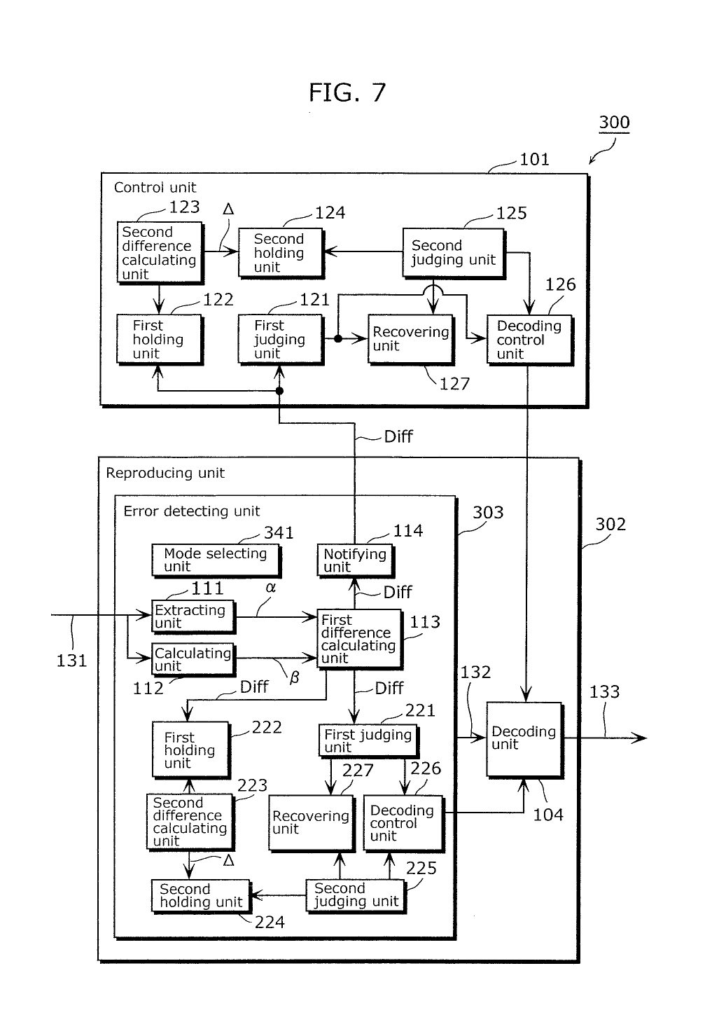

FIG. 7 is a block diagram showing the structure of the audio reproducing apparatus in the third embodiment of the present invention. Note that the same elements as those in FIG. 1 and FIG. 5 share the same numerical references. Thus, detailed description shall be omitted.

An audio reproducing apparatus 300 shown in FIG. 7 decodes an audio data stream 131 and outputs the decoded audio data stream 131 as decoded audio data 133. The audio reproducing apparatus 300 includes a control unit 101 and a reproducing unit 302.

The reproducing unit 302 decodes the audio data stream 131, as well as detects the error therein. The reproducing unit 302 includes a dedicated circuit (hardware) to the unit;that is, for example, a semi-conductor integrated circuit structured of one or more chips. The reproducing unit 302 includes an error detecting unit 303 and a decoding unit 104.

The error detecting unit 303 detects the error in the audio data stream 131. The error detecting unit 303 includes an extracting unit 111, a calculating unit 112, a first difference calculating unit 113, a notifying unit 114, a first judging unit 221, a first holding unit 222, a second difference calculating unit 223, a second holding unit 224, a second judging unit 225, a decoding control unit 226, a recovering unit 227, and a mode selecting unit 341.

The mode selecting unit 341 selects one of an automatic recovery mode (a first state) and a second state. Here, the first state causes the reproducing unit 302 to control whether or not: reproduction is to be continued; and recovery processing is to be performed, and the second state causes the control unit 101 to control whether or not: reproduction is to be continued; and recovery processing is to be performed. For example, the mode selecting unit 341, controlled by the control unit 101, selects one of the first state and the second state.

In the first state, the first judging unit 221 judges whether or not a position α matches with a position β. Here, the position α is shown with a First_access_unit_pointer 157 which has been extracted by the extracting unit 111, and the position β is calculated by the calculating unit 112.

In the first state, the second judging unit 225 judges availability of reproduction for audio data 155 included in the audio data stream 131 according to change of differences Diff which are calculated by the first difference calculating unit 113 and each of which is calculated for respective plural packets 150.

In the second state, the first judging unit 121 judges whether or not the position α matches with the position β. Here, the position α is shown with the First_access_unit_pointer 157 which has been extracted by the extracting unit 111, and the position β is calculated by the calculating unit 112.

In the second state, the second judging unit 125 judges the availability of the reproduction for the audio data 155 included in the audio data stream 131 according to change of differences Diff which are calculated by the first difference calculating unit 113 and each of which is calculated for respective plural packets 150.

In the first state, the decoding unit 104 decodes the audio data 155 included in the audio data stream 132 in the case where: the fist judging unit 221 judges the position α matches the position β; or the second judging unit 225 judges the audio data 155 to be reproducible. In the first state, the decoding unit 104 does not decode the audio data 155 included in the audio data stream 132 in the case where: the fist judging unit 221 judges that the position α does not match the position β; and the second judging unit 225 judges the audio data 155 to be irreproducible. In the second state, the decoding unit 104 decodes the audio data 155 included in the audio data stream 132 in the case where: the fist judging unit 121 judges the differences Diff to be constant; or the second judging unit 125 judges the audio data 155 to be reproducible. In the second state, the decoding unit 104 does not decode the audio data 155 included in the audio data stream 132 in the case where: the fist judging unit 121 judges the differences Diff to be not constant; and the second judging unit 125 judges the audio data 155 to be irreproducible.

Next, operations of the audio reproducing apparatus 300 in the third embodiment of the present invention shall be described.

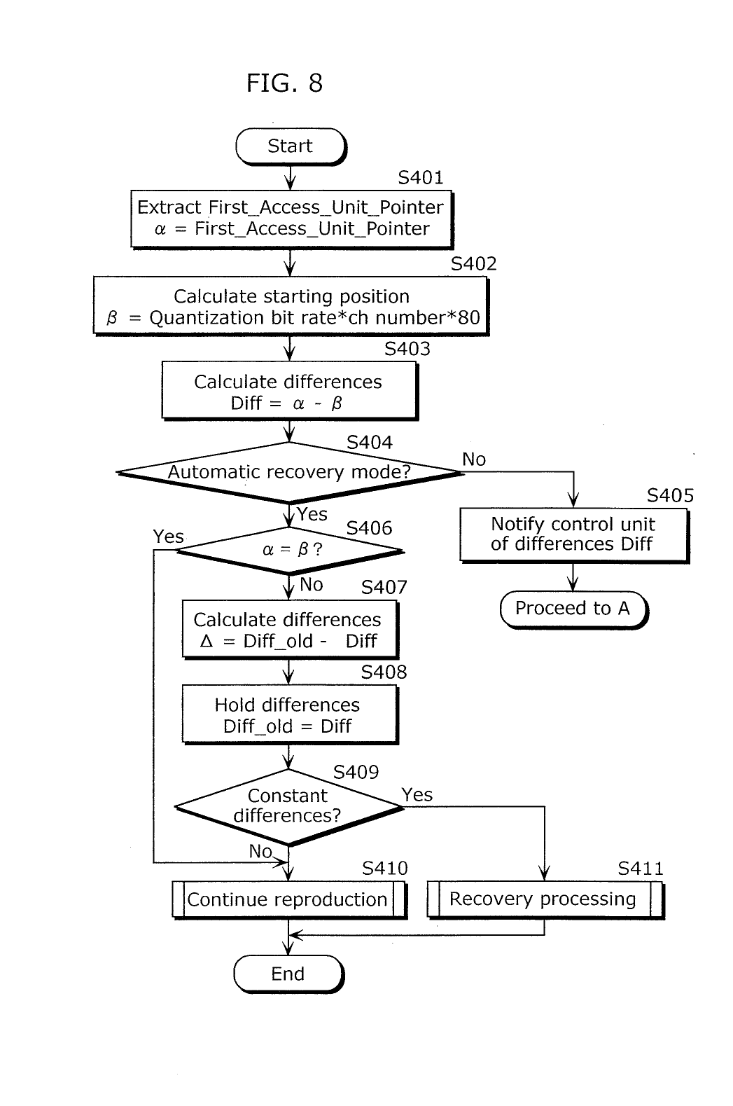

FIG. 8 is a flowchart showing a flow of processing in the error detecting unit 303.

Processing from Steps S401 to S403 shown in FIG. 8 is equivalent to that from Steps S101 to S103 in FIG. 3, thus the description shall be omitted.

After Step S403, the mode selecting unit 341 judges the audio reproducing apparatus 300 to be one of the first state and the second state based on the control by the control unit 101. Here, in the first state, the reproducing unit 302 controls whether or not: reproduction is to be continued; and recovery processing is to be performed, and in the second state, the control unit 101 controls whether or not: reproduction is to be continued; and recovery processing is to be performed (S404).

In the case of the first state (S404: Yes), the reproducing unit 302 continues processing from Steps S406 to S411. Note that the processing from Steps S406 to S411 is equivalent to that from Steps S304 to S309 in FIG. 6, thus the description shall be omitted.

In the case of the second state (S404: No), the notifying unit 114 notifies the control unit 101 of the differences Diff calculated by the first difference calculating unit 113 (S405). Based on the differences Diff notified by the notifying unit 114, the control unit 101 controls whether or not: reproduction is to be continued; and recovery processing is to be performed. Note that processing following Step S405 in the control unit 101 is the same as that in FIG. 4, and thus the description shall be omitted.

Through the above operations, the mode selecting unit 341 selects the audio reproducing apparatus 300 in the third embodiment of the present invention to be in one of the first state and the second state. In the first state, the reproducing unit 302 calculates a difference Δ and controls whether or not: reproduction is to be continued; and recovery processing is to be performed. Meanwhile, the control unit 101 neither calculates the difference Δ nor controls whether or not: reproduction is to be continued; and recovery processing is to be performed. In other words, in the first state, the same processing described in the above mentioned first embodiment is performed. In the second state, the control unit 101 calculates the difference Δ and controls whether or not: reproduction is to be continued; and recovery processing is to be performed. Meanwhile, the reproducing unit 302 neither calculates the difference Δ nor controls whether or not: reproduction is to be continued; and recovery processing is to be performed. In other words, in the second state, the same processing described in the above mentioned second embodiment is performed. As a result, the audio reproducing apparatus 300 in the third embodiment of the present invention can perform error recovery processing with the most appropriate scheme for the system by providing an interface of which an operation mode is addressable.

Note that in the above description, the control unit 101 intents to perform the processing in the FIG. 4 of the second state. In the meantime, part of processing in FIG. 4 may be performed by the reproducing unit 302. For example, in the second state, the reproducing unit 302 may perform processing up to the calculation of the differences Δ (S408) and notify the control unit 101 of the differences Δ. Here, the control unit 101 may judge whether or not the differences Δ are constant (S205) and perform the following processing.

In the above description, the mode selecting unit 341 selects one of the first state and second state. In addition, the mode selecting unit 341 may select two or more states. For example, as described above, the reproducing unit 302 may additionally perform processing up to the calculation of the differences Δ as a third state.

Moreover, in the above description, the control unit 101 intends to include the first holding unit 122 and the second holding unit 124; however, the first holding unit 122 and the second holding unit 124 may be omitted. In the second state as well, for example, the differences Diff calculated by the first difference calculating unit 113 may be held in one of the first holding unit 222 and a holding unit (such as a RAM) which is included in either the reproducing unit 302 or the audio reproducing apparatus 300. Furthermore, the differences Δ calculated by one of the second difference calculating unit 123 and the second calculating unit 223 may be held in the holding unit (such as a RAM) which is included in either the reproducing unit 302 or the audio reproducing apparatus 300.

Further, in the above description the control unit 101 intends to include the first judging unit 121, the first holding unit 122, the second calculating unit 123, the second holding unit 124, the second judging unit 125, the decoding control unit 126, and the recovering unit 127; meanwhile, depending on a system, the control unit 101 may omit some or all of the first judging unit 121, the first holding unit 122, the second calculating unit 123, the second holding unit 124, the second judging unit 125, the decoding control unit 126, and the recovering unit 127. For example, in the case where only the first state is used, the control unit 101 may omit the first judging unit 121, the first holding unit 122, the second calculating unit 123, the second holding unit 124, the second judging unit 125, the decoding control unit 126, and the recovering unit 127.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to audio reproducing apparatuses, in particular, to an audio reproducing apparatus which reproduces Linear PCM music data.

What is claimed is:

1. An audio reproducing apparatus which decodes an audio data stream including audio packets to be consecutively inputted, each of the audio packets including: coded audio data which has been coded and includes plural audio frames; starting position information indicating a first position of a starting audio frame among the plural audio frames; and audio data information which indicates the coded audio data, said audio reproducing apparatus comprising:
an extracting unit operable to extract the starting position information from the audio packet;
a position calculating unit operable to calculate, for the audio frame, a second position indicating the starting audio frame among the plural audio frames included in the audio packet, based on the audio data information included in the audio packet;
a first difference calculating unit operable to calculate, on the audio packet basis, differences between the respective first positions indicated in the starting position information extracted by said extracting unit and the respective second positions calculated by said position calculating unit;
a first reproduction judging unit operable to judge availability of reproduction for the coded audio data, based on a change in the differences calculated by said first difference calculating unit, the differences being calculated for the audio packets; and
a decoding unit operable to selectively decode the coded audio data in the case where said first reproduction judging unit judges the coded audio data to be reproducible, and to not decode the coded audio data in the case where said reproduction judging unit judges the coded audio data to be irreproducible.

2. The audio reproducing apparatus according to claim 1, further comprising:
a first holding unit for holding the differences calculated by said first difference calculating unit;
a second difference calculating unit operable to calculate a difference between a difference calculated for a preceding audio packet out of two audio packets included in the audio packets and held in said first holding unit and a difference calculated for a succeeding audio packet out of the two audio packets included in the audio packets and calculated by said first difference calculating unit; and
a second holding unit for holding the differences calculated by said second difference calculating unit,
wherein said first reproduction judging unit is operable to judge the coded audio data to be: reproducible in the case where the differences held in said second holding unit are constant; and irreproducible in the case where the differences held in said second holding unit are not constant.

3. The audio reproducing apparatus according to claim 1, further comprising
a first error judging unit operable to judge whether or not the first positions indicated in the starting position information extracted by said extracting unit match the corresponding second positions calculated by said position calculating unit, respectively,
wherein said decoding unit is operable to selectively: decode the coded audio data in the case where said first error judging unit judges that the first positions match the corresponding second positions, or in the case where said first reproduction judging unit judges the coded audio data to be reproducible; and not decode the coded audio data in the case where said first error judging unit judges that the first positions do not match the corresponding second positions, and said first reproduction judging unit judges the coded audio data to be irreproducible.

4. The audio reproducing apparatus according to claim 3, further comprising
a recovering unit operable to perform recovery processing in the case where: said first error judging unit judges that the first positions do not match the corresponding second positions; and said first reproduction judging unit judges the coded audio data to be irreproducible.

5. The audio reproducing apparatus according to claim 3, comprising:
a reproducing unit constructed in hardware and including said extracting unit, said position calculating unit, said first difference calculating unit, and said decoding unit; and
a control unit operable to control said reproducing unit, said control unit including said first error judging unit and said first reproduction judging unit, and being controlled by software,
wherein said reproducing unit further includes a notifying unit operable to notify said control unit of the differences calculated by said first difference calculating unit.

6. The audio reproducing apparatus according to claim 3, comprising:
a reproducing unit constructed in hardware, and including said extracting unit, said position calculating unit, said first difference calculating unit, said first error judging unit, said reproduction judging unit, and said decoding unit; and
a control unit being controlled by software and operable to control said reproducing unit.

7. The audio reproducing apparatus according to claim 6,
wherein said reproducing unit further includes a selecting unit operable to select one of a first state and a second state,
in the first state, said first error judging unit is operable to judge whether or not the first positions indicated in the starting position information extracted by said extracting unit match the corresponding second positions calculated by said position calculating unit, respectively,
in the first state, said first reproduction judging unit is operable to judge the availability of the reproduction for the coded audio data, based on the change in the differences calculated by said first difference calculating unit, the differences being calculated for the audio packets,
said control unit further includes:
a second error judging unit operable to judge, in the second state, whether or not the first positions indicated in the starting position information extracted by said extracting unit match the corresponding second positions calculated by said position calculating unit, respectively; and
a second reproduction judging unit operable to judge, in the second state, the availability of the reproduction for the coded audio data, based on the change in the differences calculated by said first difference calculating unit, the differences being calculated for the audio packets, and
in the first state, said decoding unit is operable to selectively: decode the coded audio data in the case where said first error judging unit judges the first positions match the corresponding second positions, or in the case where said first reproduction judging unit judges the coded audio data to be reproducible; and not decode the coded audio data in the case where said first error judging unit judges the first positions do not match the corresponding second positions, and said first reproduction judging unit judges the coded audio data to be irreproducible, and in the second state, said decoding unit is operable to selectively: decode audio data in the case where: said second error judging unit judges the first positions match the corresponding second positions; or in the case where said second reproduction judging unit judges the coded audio data to be reproducible; and not decode the coded audio data in the case where said second error judging unit judges the first positions do not match the corresponding second positions, and said second reproduction judging unit judges the coded audio data to be irreproducible.

8. The audio reproducing apparatus according to claim 1,
wherein the starting position information is included in the First Access Unit Pointer.

9. The audio reproducing apparatus according to claim 1,
wherein the audio data information includes:
information indicating a quantization bit rate of the coded audio data;
information indicating a channel number of the coded audio data; and
information indicating a sampling frequency of the coded audio data, and
said position calculating unit is operable to calculate, based on the quantization bit rate, the channel number, and the sampling frequency, the first position of the starting audio frame among the plural audio frames.

10. An audio reproducing method for an audio reproducing apparatus which decodes an audio data stream including audio packets to be consecutively inputted, each of the audio packets including: coded audio data which has been coded and includes plural audio frames; starting position information indicating a first position of a starting audio frame among the plural audio frames; and audio data information which indicates the coded audio data, said audio reproducing method comprising:
extracting the starting position information from the audio packet;
position calculating, for the audio frame, a second position of the starting audio frame among the plural audio frames included in the audio packet, based on the audio data information included in the audio packet;
a first difference calculating, on the audio packet basis, differences between the respective first positions indicated in the starting position information extracted in said extracting and the respective second positions calculated in said position calculating;
reproduction judging availability of reproduction for the coded audio data, based on a change in the differences calculated in said first difference calculating, the differences being calculated for the audio packets; and
selectively decoding the coded audio data in the case where the coded audio data is judged to be reproducible, and not decoding in the case where the coded audio data is judged to be irreproducible.

11. A computer-readable program product for an audio reproducing method for use in an audio reproducing apparatus which decodes an audio data stream including audio packets to be consecutively inputted, each of the audio packets including: coded audio data which has been coded and includes plural audio frames; starting position information indicating a first position of a starting audio frame among the plural audio frames; and audio data information which indicates the coded audio data, said program product allowing, when loaded into the apparatus, the apparatus to execute:
extracting the starting position information from the audio packet;
position calculating, for the audio frame, a second position of the starting audio frame among the plural audio frames included in the audio packet, based on the audio data information included in the audio packet;
a first difference calculating, on the audio packet basis, differences between the respective first positions indicated in the starting position information extracted in the extracting and the respective second positions calculated in the position calculating;
reproduction judging availability of reproduction for the coded audio data, based on a change in the differences calculated in the first difference calculating, the differences being calculated for the audio packets; and
selectively decoding the coded audio data in the case where the coded audio data is judged to be reproducible, and not decoding in the case where the coded audio data is judged to be irreproducible.
